(19) United States
(12) Patent Application Publication
(10) Pub. No.: US 2011/0225305 A1
(43) Pub. Date: Sep. 15, 2011

(54) SYSTEM AND METHOD FOR DETERMINING GROUP OWNER INTENT

(75) Inventors: Ramanuja VEDANTHAM, Allen, TX (US); Ariton E. XHAFA, Plano, TX (US); Yanjun SUN, Richardson, TX (US)

(73) Assignee: TEXAS INSTRUMENTS INCORPORATED, Dallas, TX (US)

(21) Appl. No.: 13/045,132

(22) Filed: Mar. 10, 2011

Related U.S. Application Data
(60) Provisional application No. 61/312,403, filed on Mar. 10, 2010.

(51) Int. Cl. G06F 15/16

(52) U.S. Cl. 709/227

(57) ABSTRACT

A system comprising a first wireless device which comprises a first group owner intent determination unit. The first group owner intent determination unit is configured to determine a group owner intent value of the first wireless device based on: whether the first wireless device is configured to access a coexisting wireless network, the power remaining in the first wireless device at the time the group owner intent value determination is made, whether the first wireless device is a group owner in another peer to peer group, a received signal strength indication of the first wireless device, and/or whether the first wireless device is required to perform a cross-connection between an infrastructure basic service set and a peer to peer group.

### CROSS-REFERENCE TO RELATED APPLICATION

The present application claims priority to U.S. Provisional Patent Application No. 61/312,403, filed on Mar. 10, 2010 (Attorney Docket No. TI-69185PS) entitled “Group Owner Negotiation in Wi-Fi Direct Devices” which is hereby incorporated herein by reference in its entirety.

### BACKGROUND

The use of wireless devices is increasing rapidly. Wireless devices, such as consumer electronic devices and mobile handsets, configured with Wi-FDirect enable users to communicate content by allowing them to connect with other wireless devices without an infrastructure network located in the vicinity.

One way to accomplish the connection of wireless devices to each other in a peer to peer group is to provide the functionality of a traditional infrastructure Access Point in software in a wireless device so that the device operates as a group owner, behaving in a similar manner as the traditional infrastructure Access Point. With the functionality of an Access Point, other wireless devices have the capability of setting up connections with the mobile group owner as peer to peer clients. Typically, Access Point functionality provided by the wireless device is, for the most part, provided by software. The group owner wireless device is sometimes referred to as a Soft Access Point.

### SUMMARY

A system and method for determining group owner intent in a wireless device. In one embodiment, a wireless device comprises a wireless transmitter, a wireless receiver, and a group owner intent determination unit. The group owner intent determination unit is configured to determine a value of the wireless device which is used to determine a group owner in a peer to peer group based on whether the wireless device is configured to access a coexisting wireless network.

In another embodiment, a method includes identifying, by a wireless device, whether the wireless device is required to perform a cross-connection between an infrastructure basic service set and a peer to peer group. The method also includes identifying, by the wireless device, whether the wireless device is configured to access a coexisting wireless network. The method also includes determining, by the wireless device, a group owner intent value of the wireless device based on whether the wireless device is required to perform a cross-connection between an infrastructure basic service set and a peer to peer group and based on whether the wireless device is configured to access a coexisting wireless network.

In a further embodiment, a system includes a first wireless device which comprises a first group owner intent determination unit. The first group owner intent determination unit is configured to determine a group owner intent value of the first wireless device based on: whether the first wireless device is configured to access a coexisting wireless network, the power remaining in the first wireless device at the time the group owner intent value determination is made, whether the first wireless device is a group owner in another peer to peer group, or a received signal strength indication of the first wireless device.

### BRIEF DESCRIPTION OF THE DRAWINGS

For a detailed description of exemplary embodiments of the invention, reference will now be made to the accompanying drawings in which:

FIG. 1 shows a wireless system including two wireless devices configured to communicate with one another in a peer to peer group in accordance with various embodiments;

FIG. 2 shows a flow diagram for determining group owner intent value of a wireless device;

FIG. 3 shows a flow diagram for group owner negotiation between peer to peer devices; and

FIG. 4 shows a flow diagram for determining the group owner during a group owner negotiation between peer to peer devices.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In order to achieve the separation of functionalities between two peer devices in a peer to peer group, i.e. group owner or peer to peer (“p2p”) client, a group negotiation procedure must take place. More specifically, when two wireless devices arrive on a common channel, they must enter into a group owner negotiation to determine which wireless device becomes the group owner of the peer to peer group and acts as the Soft Access Point for the peer to peer group. Embodiments of the present disclosure provide an efficient way for wireless devices to negotiate with one another as to which wireless device will become the group owner in a peer to peer group.

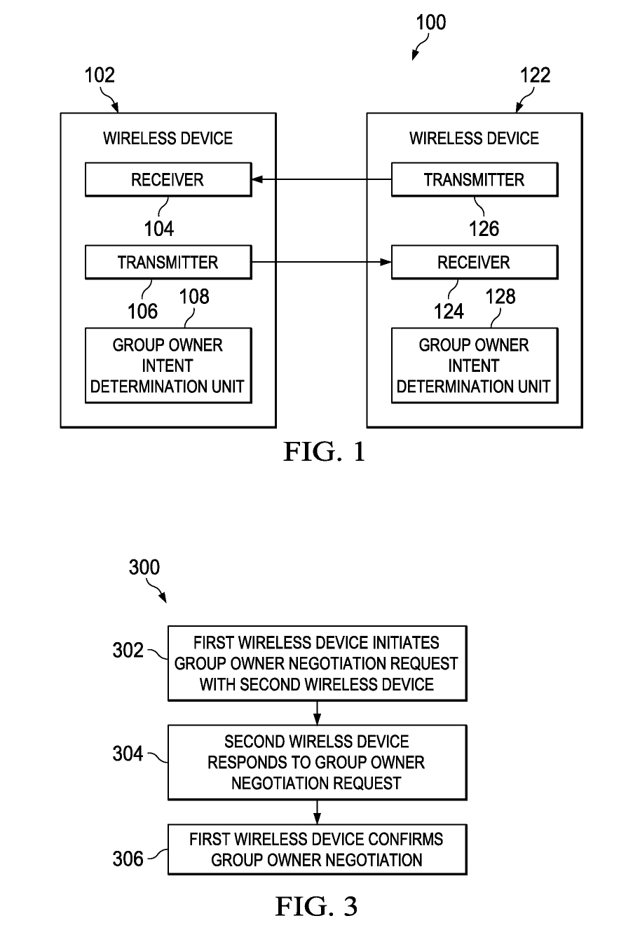

FIG. 1 shows a peer to peer group 100 including wireless devices 102 and 122. Mobile telephones, laptop computers, personal digital assistants, radios, consumer electronic devices, and integrated circuits may serve as wireless device 102 and/or 122; however, any device that is capable of communicating with another device without being physically connected to the other device may also serve as wireless device 102 and/or 122.

Wireless device 102 includes receiver 104, transmitter 106, and group owner intent determination unit 108. Wireless device 122 includes receiver 124, transmitter 126, and group owner intent determination unit 128. Wireless device 102, through transmitter 106 and receiver 104, is configured to communicate with the wireless device 122 and its transmitter 126 and receiver 124 via a wireless network. Thus, wireless devices 102 and 122 may form a peer to peer group in which one of the wireless devices 102 and 122 may function as the group owner, and thus as a Soft Access Point. While only two wireless devices are depicted, in some embodiments, any number of wireless devices may join the peer to peer group. In other embodiments, the peer to peer group is limited to 8 wireless devices.

In some embodiments of the system 100, the wireless devices 102 and 122 are configured to communicate with one another in accordance with the Wi-Fi Peer-to-Peer protocol (e.g., Wi-Fi Direct). In some embodiments, transmitters 106 and 126 and receivers 104 and 124 are configured for communication according to another wireless standard, such as the WLAN protocol (e.g., IEEE 802.11 b/g/n). The wireless devices 102 and 122 may include a second transmitter and receiver pair configured for communication via a second (coexisting) wireless network using a protocol different from that of the first wireless network (e.g., over a BLUETOOTH network). Coexisting wireless networks may use overlapping or adjacent frequency resources, requiring that a wireless device accessing coexisting networks manage access to the networks to mitigate inter-network interference.

Wireless device 102 also includes group owner intent determination unit 108. Wireless device 122 includes group owner intent determination unit 128. Group owner intent determination units 108 and 128 are configured to determine a group owner intent value which is a value used by the wireless devices 102 and 122 in determining which wireless device will be the group owner during the group owner negotiation. Group owner intent determination units 108 and 128 may be implemented in either hardware or a processor executing software.

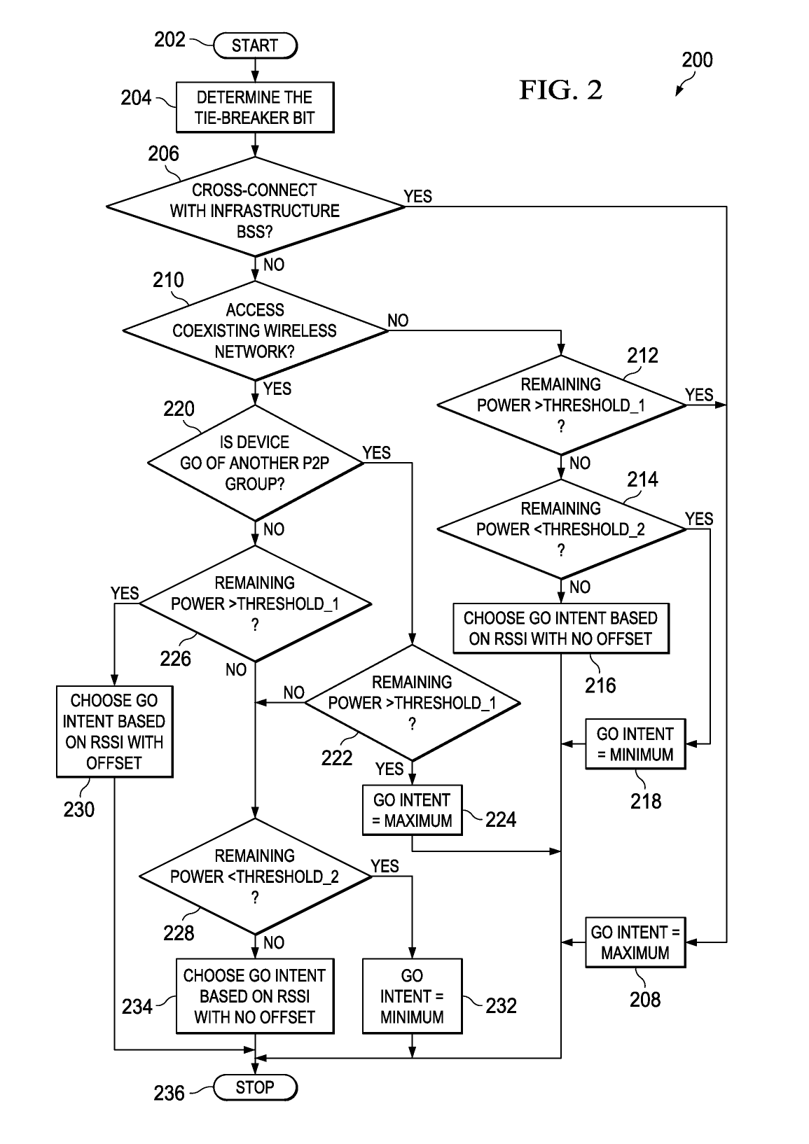

FIG. 2 shows a flow diagram 200 for determining the group owner intent value of a wireless device such as wireless devices 102 and 122 from FIG. 1. Though depicted sequentially as a matter of convenience, at least some of the actions shown can be performed in a different order and/or performed in parallel. Additionally, some embodiments may perform only some of the actions shown. In some embodiments, at least some of the operations of FIG. 2, as well as other operations described herein, can be implemented as instructions stored in a computer readable medium and executed by a processor.

Group owner intent determination unit 108 may be utilized for determining the group owner intent value for wireless device 102 while group owner intent determination unit 128 may be utilized for determining the group owner intent value for wireless device 122.

The flow diagram begins at block 202 and proceeds to block 204. In block 204, a tiebreaker bit must be determined. The tiebreaker bit may be a randomly generated number, in some embodiments 0 or 1, which may be assigned by the group owner intent determination unit 108 and/or 128 with respect to a specific group owner negotiation.

The flow diagram continues in block 206 where a determination must be made, in some embodiments by the group owner intent determination unit 108 and/or 128, as to whether the wireless device 102 and/or 122 is required to perform a cross-connection between an infrastructure basic service set and the peer to peer group. A cross connection between an infrastructure basic service set and the peer to peer group may mean that wireless devices 102 and/or 122 act as a bridge/router forwarding traffic from/to the infrastructure interface to/from the peer to peer group interface. If wireless device 102 and/or 122 is required to perform a cross-connection between an infrastructure basic service set and the peer to peer group, then the method continues in block 208 where the group owner intent value is set to a maximum value, in some embodiments 15, for that wireless device and the method ends in block 236.

However, if the wireless device 102 and/or 122 is not required to perform a cross-connection between an infrastructure basic service set and the peer to peer group, the method continues in block 210. In block 210, a determination is made, in some embodiments by the group owner intent determination unit 108 and/or 128, as to whether the wireless device is configured to access a coexisting wireless network, in some embodiments a BLUETOOTH network. If wireless device 102 and/or 122 is not configured to access a coexisting wireless network, then the method continues in block 212.

In block 212, a determination is made, in some embodiments by the group owner intent determination unit 108 and/or 128, as to whether the power remaining in the wireless device 102 and/or 122 is greater than a first preset threshold level. If the power remaining in the wireless device 102 and/or 122 is greater than the first preset threshold level, then, as shown in block 208, the group owner intent value is set to the maximum value, in some embodiments 15, for that wireless device and the method ends in block 236.

However, if the power remaining in the wireless device 102 and/or 122 is less than or equal to the first preset threshold level, it must be determined, in some embodiments by the group owner intent determination unit 108 and/or 128, whether the power remaining in the wireless device 102 and/or 122 is less than a second preset threshold level, as shown in block 214. The second preset threshold level may be less than the first preset threshold level.

If the power remaining in the wireless device 102 and/or 122 is less than the second preset threshold level, then the method continues in block 218 where the group owner intent value is set to a minimum value, in some embodiments 0, for that wireless device and the method ends in block 236. Because, for the most part, wireless devices 102 and 122 are battery operated, wireless devices 102 and 122 have limited resources and the power of the wireless devices 102 and 122 may be a consideration in determining the group owner intent value.

If the power remaining in wireless device 102 and/or 122 is greater than or equal to the second preset threshold level, and thus, between the first preset threshold level and the second preset threshold level, the group owner intent value is set to a value based on the received signal strength indication of the wireless device with respect to other wireless devices in the peer to peer group, as indicated in block 216, and the method ends in block 236. In some embodiments, the higher the received signal strength indication of the wireless device, the higher the group owner intent value. In some embodiments, the value of the received signal strength indication of the wireless device is set to a number between 1 and 7.

If in block 210, it is determined that the wireless device 102 and/or 122 is configured to access a coexisting wireless network, then the method continues in block 220. In block 220 a determination is made, in some embodiments by the group owner intent determination unit 108 and/or 128, as to whether the wireless device 102 and/or 122 is a group owner for another separate peer to peer group. If the wireless device 102 and/or 122 is the group owner in another peer to peer group the method continues in block 222.

In block 222, a determination is made, in some embodiments by the group owner intent determination unit 108 and/or 128, as to whether the power remaining in the wireless device 102 and/or 122 is greater than the first preset threshold level. If the power remaining in the wireless device 102 and/or 122 is greater than the first preset threshold level, then, as shown in block 224, the group owner intent value is set to the maximum value, in some embodiments 15, for that wireless device and the method ends in block 236.

However, if the power remaining in the wireless device 102 and/or 122 is less than or equal to the first preset threshold level, it must be determined, in some embodiments by the group owner intent determination unit 108 and/or 128, whether the power remaining in the wireless device 102 and/or 122 is less than a second preset threshold level, as shown in block 228. If the power remaining in the wireless device 102 and/or 122 is less than the second preset threshold level, then method continues in block 232 where the group owner intent value is set to the minimum value, in some embodiments 0, for that wireless device and the method ends in block 236.

If the power remaining in wireless device 102 and/or 122 is greater than or equal to the second preset threshold level, and thus, between the first preset threshold level and the second preset threshold level, the group owner intent value is set to a value based on the received signal strength indication of the wireless device to other wireless devices in the peer to peer group, as indicated in block 234, and the method ends in block 236. In some embodiments, the higher the received signal strength indication of the wireless device, the higher the group owner intent value. In some embodiments, the value of the received signal strength indication of the wireless device is set to a number between 1 and 7.

If, in block 220, it is determined that the wireless device 102 and/or 122 is not a group owner in a separate peer to peer group, then the method continues in block 226. In block 226, a determination is made, in some embodiments by the group owner intent determination unit 108 and/or 128, as to whether the power remaining in the wireless device 102 and/or 122 is greater than the first preset threshold level. If the power remaining in the wireless device 102 and/or 122 is greater than the first preset threshold level, then, as shown in block 230, the group owner intent value is set to a value based on an offset of the received signal strength indication of the wireless device to other wireless devices in the peer to peer group, as indicated in block 234, and the method ends in block 236. In some embodiments, the higher the received signal strength indication of the wireless device, the higher the group owner intent value. In some embodiments, the value of the received signal strength indication of the wireless device is set to a number between 1 and 7. The offset may be added to the value of the received signal strength indication of the wireless device. The offset that may be added to the value of the received signal strength indication of the wireless device may be 8. The offset, in this block, is included to provide a higher group owner intent value for wireless devices that have higher power levels.

However, if the power remaining in the wireless device 102 and/or 122 is less than or equal to the first preset threshold level, it must be determined, in some embodiments by the group owner intent determination unit 108 and/or 128, whether the power remaining in the wireless device 102 and/or 122 is less than a second preset threshold level, as shown in block 228. If the power remaining in the wireless device 102 and/or 122 is less than the second preset threshold level, then method continues in block 232 where the group owner intent value is set to the minimum value, in some embodiments 0, for that wireless device and the method ends in block 236.

If the power remaining in wireless device 102 and/or 122 is greater than or equal to the second preset threshold level, and thus, between the first preset threshold level and the second preset threshold level, the group owner intent value is set to a value based on the received signal strength indication of the wireless device to other wireless devices in the peer to peer group, as indicated in block 234, and the method ends in block 236. In some embodiments, the higher the received signal strength indication of the wireless device, the higher the group owner intent value. In some embodiments, the value of the received signal strength indication of the wireless device is set to a number between 1 and 7.

Thus, the determination of the group owner intent value of wireless devices 102 and/or 122 may be based on whether the wireless devices 102 and/or 122 are required to perform a cross-connection between an infrastructure basic service set and a peer to peer group, whether the wireless devices 102 and/or 122 are configured to access a coexisting wireless network, the power remaining in the wireless devices 102 and/or 122 at the time the group owner intent value determination is made, whether the wireless devices 102 and/or 122 are a group owner in another peer to peer group, and/or a received signal strength indication of the wireless devices 102 and/or 122.

FIG. 3 shows a flow diagram 300 for group owner negotiation between two peer to peer devices such as wireless devices 102 and 122 from FIG. 1. Though depicted sequentially as a matter of convenience, at least some of the actions shown can be performed in a different order and/or performed in parallel. Additionally, some embodiments may perform only some of the actions shown. In some embodiments, at least some of the operations of FIG. 3, as well as other operations described herein, can be implemented as instructions stored in a computer readable medium and executed by a processor.

In block 302, wireless device 102 initiates a group owner negotiation request with second wireless device 122 to determine which peer to peer device will be the group owner in a peer to peer group, and thus act as a Soft Access Point. During this step, the wireless device 102 may communicate information such as its peer to peer capability, peer to peer device information, its group owner intent value, configuration timeout, the intended peer to peer interface address, channel list, and channel attributes to wireless device 122.

In block 304, the second wireless device 122 responds to the group owner request. In doing so, the wireless device 122 may communicate information such as its peer to peer capability, peer to peer device information, its group owner intent value, configuration timeout, the intended peer to peer interface address, channel list, and channel attributes to wireless device 102.

In block 306, wireless device 102 confirms the group owner negotiation. In doing so, wireless device 102 may communicate the peer to peer capability, status of the negotiation, channel list, and channel attributes.

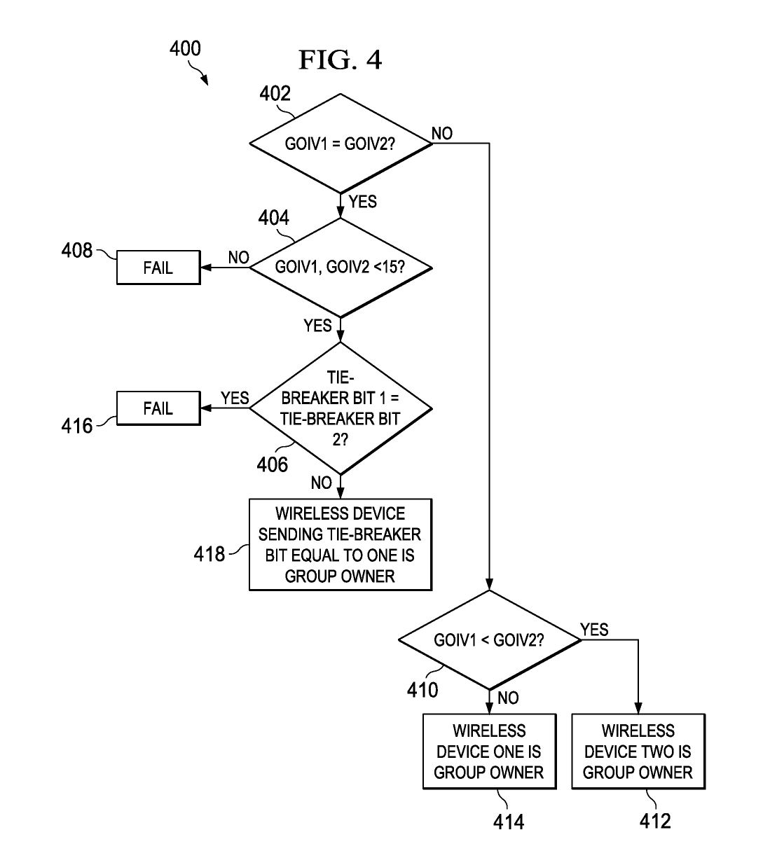

FIG. 4 shows a flow diagram 400 for determining the group owner during a group owner negotiation between peer to peer devices such as wireless devices 102 and 122 from FIG. 1. Though depicted sequentially as a matter of convenience, at least some of the actions shown can be performed in a different order and/or performed in parallel. Additionally, some embodiments may perform only some of the actions shown. In some embodiments, at least some of the operations of FIG. 4, as well as other operations described herein, can be implemented as instructions stored in a computer readable medium and executed by a processor.

As shown in FIG. 4, the group owner may be determined by the group owner intent value of the wireless devices 102 and 122. In block 402, a determination is made as to whether the group owner intent value of wireless device 102 is equal to the group owner intent value of wireless device 122.

If the group owner intent value of wireless devices 102 and 122 are equal, then the method continues at block 404. In block 404, a determination is made as to whether the group owner intent value of wireless devices 102 and 122 are less than the maximum value, in some embodiments 15. If the group owner intent value of the wireless devices 102 and 122 are less than the maximum value, then a determination is made as to whether the randomly generated tiebreaker bit of wireless device 102 equals the tiebreaker bit of wireless device 122, as depicted in block 406. If both wireless devices 102 and 122 are randomly assigned the same tiebreaker bit, then the group owner negotiation fails, as shown in block 416, and the wireless devices must reenter group negotiation to determine a group owner. However, if the tiebreaker bit in wireless device 102 does not equal the tiebreaker bit in wireless device 122, then the group owner is determined by the randomly generated tiebreaker bit, as depicted in block 418. In some embodiments, the group owner is determined to be the wireless device 102 or 122 that has the tiebreaker bit of 1.

If the group owner intent value of wireless devices 102 and 122 is equal to the maximum value, in some embodiments 15, then the group owner negotiation fails, as shown in block 408, because both wireless devices want to become the group owner. The wireless devices then must reenter group negotiation to determine a group owner.

As shown in block 410, if the group owner intent value of wireless devices 102 and 122 are not equal, a determination must be made as to whether the group owner intent value of wireless device 102 is less than the group owner intent value of wireless device 122. If the group owner intent value of wireless device 102 is less than the group intent value of wireless device 122, then wireless device 122 is determined to be the group owner, as depicted in block 412. However, if the group owner intent value of wireless device 102 is not less than the group owner intent value of wireless device 122, then wireless device 102 is determined to be the group owner.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a wireless transmitter;
a wireless receiver; and
a group owner intent determination unit,
wherein the group owner intent determination unit is configured to determine a value of the wireless device which is used to determine a group owner in a peer to peer group based on whether the wireless device is configured to access a coexisting wireless network.

2. The wireless device of claim 1, wherein the group owner intent determination unit is further configured to determine the value of the wireless device which is used to determine a group owner in a peer to peer group based on the power remaining in the wireless device at the time the value determination is made.

3. The wireless device of claim 1, wherein the group owner intent determination unit is further configured to determine the value of the wireless device which is used to determine a group owner in a peer to peer group based on whether the wireless device is a group owner in another peer to peer group.

4. The wireless device of claim 1, wherein the group owner intent determination unit value is further configured to determine the value of the wireless device which is used to determine a group owner in a peer to peer group based on a received signal strength indication of the wireless device.

5. A method, comprising:
identifying, by a wireless device, whether the wireless device is required to perform a cross-connection between an infrastructure basic service set and a peer to peer group;
identifying, by the wireless device, whether the wireless device is configured to access a coexisting wireless network;
determining, by the wireless device, a group owner intent value of the wireless device based on whether the wireless device is required to perform a cross-connection between an infrastructure basic service set and a peer to peer group and based on whether the wireless device is configured to access a coexisting wireless network.

6. The method of claim 5, wherein the determining the group owner intent value based on whether the wireless device is required to perform a cross-connection between an infrastructure basic service set and a peer to peer group comprises:
setting the group owner intent value to a maximum value based on the wireless device being required to perform a cross-connection between an infrastructure basic service set and the peer to peer group.

7. The method of claim 5, wherein the determining the group owner intent value based on whether the wireless device is configured to access a coexisting wireless network comprises:
determining, by the wireless device, the group owner intent value based on the power remaining in the wireless device at the time the group owner intent value determination is made in response to the wireless device not being configured to access a coexisting wireless network.

8. The method of claim 7, wherein the determining the group owner intent value based on the available power remaining in the wireless device at the time the group owner intent value determination is made comprises:
setting the group owner intent value to a maximum value based on the power of the wireless device being greater than a first threshold level;
setting the group owner intent value to a minimum value based on the power of the wireless device being less than a second threshold level; and
setting the group owner intent value to a value based on a received signal strength indication of the wireless device based on the power of the wireless device being less than or equal to the first threshold level and greater than or equal to the second threshold level.

9. The method of claim 5, wherein the determining the group owner intent value based on whether the wireless device is configured to access a coexisting wireless network comprises:
determining, by the wireless device, the group owner intent value based on whether the wireless device is a group owner in another peer to peer group in response to the wireless device being configured to access a coexisting wireless network.

10. The method of claim 9, wherein the determining the group owner intent value based on whether the wireless device is a group owner in another peer to peer group comprises:
identifying, by the wireless device, whether the wireless device is a group owner in another peer to peer group;
determining, by the wireless device, the group owner intent value based on the power remaining in the wireless device at the time the group owner intent value determination is made in response to the wireless device being configured to be the group owner in another peer to peer group.

11. The method of claim 10, wherein the determining the group owner intent value based on the available power remaining in the wireless device at the time the group owner intent value determination is made comprises:
setting the group owner intent value to a maximum value based on the power of the wireless device being greater than a first threshold level;
setting the group owner intent value to a minimum value based on the power of the wireless device being less than a second threshold level; and
setting the group owner intent value to a value based on a received signal strength indication of the wireless device based on the power of the wireless device being less than or equal to the first threshold level and greater than or equal to the second threshold level.

12. The method of claim 9, wherein the determining the group owner intent value based on whether the wireless device is a group owner in another peer to peer group comprises:
identifying, by the wireless device, whether the wireless device is a group owner in another peer to peer group;
determining, by the wireless device, the group owner intent value based on the power remaining in the wireless device at the time the group owner intent value determination is made in response to the wireless device being configured to not be the group owner in another peer to peer group.

13. The method of claim 12, wherein the determining the group owner intent value based on the available power remaining in the wireless device at the time the group owner intent value determination is made comprises:
setting the group owner intent value to a value based on an offset of a received signal strength indication of the wireless device based on the power of the wireless device being greater than a first threshold level;
setting the group owner intent value to a minimum value based on the power of the wireless device being less than a second threshold level; and
setting the group owner intent value to a value based on a received signal strength indication of the wireless device based on the power of the wireless device being less than or equal to the first threshold level and greater than or equal to the second threshold level.

14. A system, comprising:
a first wireless device comprising a first group owner intent determination unit,
wherein the first group owner intent determination unit is configured to determine a group owner intent value of the first wireless device based on: whether the first wireless device is configured to access a coexisting wireless network, the power remaining in the first wireless device at the time the group owner intent value determination is made, whether the first wireless device is a group owner in a peer to peer group, or a received signal strength indication of the first wireless device.

15. The system of claim 14, wherein the first group owner intent determination unit is further configured to determine the group owner intent value of the first wireless device based on whether the first wireless device is required to perform a cross-connection between an infrastructure basic service set and a peer to peer group.

16. The system of claim 15, further comprising a second wireless device comprising a second group owner intent determination unit,
wherein the first and second wireless devices are configured to form a peer to peer group with each other.

17. The system of claim 16, wherein the first wireless device is configured to enter into a group owner negotiation with the second wireless device.

18. The system of claim 17, wherein a group owner of the peer to peer group is determined by comparing the group owner intent value of the first wireless device to the group owner intent value of the second wireless device.

19. The system of claim 17, wherein the group owner of the peer to peer group is determined to be the first wireless device based on the first wireless device having a higher group owner intent value than the second wireless device and the second wireless device based on the second wireless device having a higher group owner intent value than the first wireless device.

20. The system of claim of claim 17, wherein the group owner of the peer to peer group is determined by a tie-breaker bit based on the first wireless device having the same group owner intent value as the second wireless device.
